(19) United States
(12) Patent Application Publication
(10) Pub. No.: US 2013/0261972 A1
(43) Pub. Date: Oct. 3, 2013

(54) PROCESS FOR DETERMINING MOBILE WATER SATURATION IN A RESERVOIR FORMATION

(71) Applicant: Nabil Al Adani, Calgary (CA)

(72) Inventor: Nabil Al Adani, Calgary (CA)

(73) Assignee: SUNCOR ENERGY INC., Calgary, Alberta (CA)

(21) Appl. No.: 13/988,009

(22) PCT Filed: Nov. 18, 2011
(86) PCT No.: PCT/CA11/01278

§ 371 Date: Jun. 18, 2013

Related U.S. Application Data
(60) Provisional application No. 61/415,275, filed on Nov. 18, 2010.

(51) Int. Cl. G01V 9/02; G01V 5/04; G01V 3/34

(52) U.S. Cl. CPC G01V 9/02; G01V 3/34; G01V 5/045
USPC 702/7; 702/8; 702/12

(57) ABSTRACT

A method for determining mobile water saturation in a reservoir having a borehole extending through the reservoir is disclosed. The method involves obtaining a first borehole data log while the reservoir is subjected to first fluid conditions, and causing a mobile water displacement in the reservoir by changing the fluid conditions in the borehole to cause the reservoir to be subjected to second fluid conditions, the second fluid conditions differing from the first fluid conditions. The method further involves obtaining a second borehole data log under the second fluid conditions, and estimating the mobile water displacement using the first and second data logs, the estimated mobile water displacement providing an estimate of the mobile water saturation in the reservoir.

### BACKGROUND OF THE INVENTION

1. Field of Invention

This invention relates generally to determining mobile water saturation in a reservoir formation.

2. Description of Related Art

Resources often reside in reservoirs below the surface of the earth. In some situations the resource is not economically accessible by direct mining of the surrounding formations. Alternative methods may be employed to access and extract the resources, such as hydrocarbons, water, or other minerals. Such resources are often in a fluid state and are trapped in a reservoir formed by the surrounding reservoir formation. Examples of such resources are ground water reservoirs, liquid hydrocarbon, and gaseous hydrocarbon reserves.

Viscous hydrocarbons or bitumen may be located in rock or sand deposits well below the surface of the earth, making mining of these reserves using conventional techniques uneconomical. Steam assisted gravity drainage (SAGD) techniques may be employed to access such reserves, but due to the high capital cost and the relatively large energy cost associated with extracting the hydrocarbons, accurate assessment of the economic potential is important prior to and during exploitation of the reserve.

In assessing the potential of a hydrocarbon recovery operation, it is common to drill a borehole into the reservoir formation to permit access to the reserve for measurement and evaluation purposes. Particularly in the case of reserves where the hydrocarbons are contained within pores of the reservoir formation, assessment of the concentration of the hydrocarbons and the concentration of other fluids such as water is important for assessing the potential of the reserve. A proper understanding of the effect of initial fluid saturations, such as mobile water saturation and irreducible water saturation is important in this evaluation. Mobile water is a portion of the water in a reservoir that that is able to move through pores in the formation. In bitumen reservoirs, the mobile water coexists in the pores with the bitumen and will move due to its effective permeability, which is higher than a critical effective permeability. The critical effective permeability is dependent on the bitumen and water distribution in the pores of the reservoir and also on the pore distribution and pore throat distribution. When acquiring a core sample of the reservoir in order to determine mobile water saturation, it is important to maintain the pore and the pore throat distribution to avoid the sample being misrepresentative of the in situ conditions in the reservoir. Bitumen bearing oil sand reservoirs generally include loose sand grains with negligible cement holding the sand grains together and core samples taken from such reservoirs will generally experience the drilling conditions as an unavoidable first impact, which may disturb the in-situ conditions. Furthermore, core samples taken from bitumen bearing oil sand reservoirs may also be particularly prone to subsequent deterioration. These problems may effectively render the core sample unsuitable for further analysis.

### SUMMARY OF THE INVENTION

In accordance with one aspect of the invention there is provided a method for determining mobile water saturation in a reservoir having a borehole extending through the reservoir. The method involves obtaining first borehole data logs while the reservoir is subjected to first fluid conditions, the first borehole data logs including a first resistivity data log, and at least one data log that facilitates direct determination of a first water volume in the reservoir. The method also involves causing a mobile water displacement in the reservoir by changing the fluid conditions in the borehole to cause the reservoir to be subjected to second fluid conditions, the second fluid conditions differing from the first fluid conditions. The method further involves obtaining second borehole data logs under the second fluid conditions, the second borehole data logs including a second resistivity data log, and at least one data log that facilitates direct determination of a second water volume in the reservoir. The method also involves estimating the mobile water displacement using the first and second data logs and, based on the estimated mobile water displacement and a determined porosity of the reservoir, determining the mobile water saturation of the reservoir.

The method may involve obtaining a porosity log of the reservoir, the porosity of the reservoir may be determined from the porosity log.

Changing the fluid conditions in the borehole may involve changing electrical conductivity properties of the fluid in the borehole and estimating the mobile water displacement may involve using the first and second resistivity logs to estimate the mobile water displacement from electrical conductivity changes between the first fluid conditions and the second fluid conditions.

Obtaining at least one of the first borehole data logs and the second borehole data logs may involve obtaining a porosity data log that facilitates determination of a porosity of the reservoir and estimating the mobile water displacement may involve using the porosity data log in estimating the mobile water displacement.

The method may involve comparing the first water saturation and the second water saturation and based on the comparison determining whether a criterion may be satisfied for generating a reliable estimate of the mobile water saturation in the reservoir based on the first and second borehole data logs.

Determining whether the criterion is satisfied may involve determining whether a difference between the first water saturation and the second water saturation is less then a threshold difference.

Obtaining each of the data logs that facilitate direct determination of the respective first and second water volumes in the reservoir may involve obtaining at least one of a nuclear magnetic resonance log, an electrical permittivity log, or a gamma spectroscopy log.

Changing the fluid conditions may involve changing fluid conditions of the fluid in the borehole to cause an immiscible displacement of water in the reservoir and estimating the mobile water displacement may involve determining a difference between the first and second water saturations.

The method may involve using a comparison of the first and second resistivity data logs to determine whether the immiscible displacement of water in the reservoir meets a criterion for generating a reliable estimate of the mobile water saturation in the reservoir.

Using a comparison of the first and second resistivity data logs to determine whether the immiscible displacement of water in the reservoir meets the criterion may involve determining whether resistivity differences between the first and second resistivity data logs may be consistent with a successful immiscible displacement of water in the reservoir.

In accordance with another aspect of the invention there is provided a method for determining mobile water saturation in a reservoir having a borehole extending through the reservoir. The method involves obtaining a first borehole data log while the reservoir is subjected to first fluid conditions, and causing a mobile water displacement in the reservoir by changing the fluid conditions in the borehole to cause the reservoir to be subjected to second fluid conditions, the second fluid conditions differing from the first fluid conditions. The method further involves obtaining a second borehole data log under the second fluid conditions, and estimating the mobile water displacement using the first and second data logs, the estimated mobile water displacement providing an estimate of the mobile water saturation in the reservoir.

Changing the fluid conditions in the borehole may involve introducing into the borehole, at least one of water, a hydrocarbon fluid, a polymer fluid, a drilling fluid, an oil-based inverted drilling fluid, steam, or an inert gas.

The first fluid conditions may be provided by a first fluid in the borehole and changing the fluid conditions in the borehole may involve circulating the first fluid out of the borehole over a circulating time period, wherein the circulating may involve drawing the first fluid from the borehole, and while drawing the first fluid from the borehole, introducing a second fluid into the borehole, the second fluid providing the second fluid conditions.

The method may involve monitoring a downhole pressure proximate a portion of the borehole in communication with the reservoir during the circulating, and controlling the circulating to maintain the downhole pressure below a threshold pressure.

The threshold pressure may correspond to a fracture pressure associated with the reservoir.

The method may involve performing a verification of the estimate of the mobile water saturation by determining whether the monitored pressure during the circulating meets a criterion for generating a reliable estimate of the mobile water saturation in the reservoir.

Determining whether the monitored pressure meets the criterion may involve determining whether the monitored downhole pressure remains below a pressure threshold associated with capillary trapping of fluid in pores of the reservoir during the circulating.

The circulating time period may have a duration of at least about 30 minutes.

The method may involve allowing a soaking time period having a duration of about 30 minutes between completion of the circulating and obtaining the second borehole data log.

The first fluid may include a drilling fluid for facilitating drilling of the borehole through the reservoir.

The method may involve determining properties of the fluid in the borehole under the first fluid conditions and determining properties of the fluid in the borehole under the second fluid conditions.

Determining the properties of the fluid in the borehole may involve determining at least one of a pH of the first fluid, a viscosity of the first fluid, a resistivity of the first fluid, a density of the first fluid, or a composition of the first fluid.

The borehole may be enclosed by a well-head proximate the surface and the method may further involve relieving an increase in pressure in the borehole proximate the surface that occurs during the changing of the fluid conditions.

The method may involve conditioning the borehole prior to obtaining the first data log.

Conditioning the borehole may involve scraping the borehole before obtaining the first data log.

The method may involve verifying the integrity of the borehole after changing the fluid conditions.

Verifying the integrity of the borehole may involve obtaining a caliper log of a diameter of the borehole through the reservoir.

Changing the fluid conditions in the borehole may involve changing electrical conductivity properties of the fluid in the borehole.

The fluid in the borehole may include a first fluid and changing the electrical conductivity properties of the fluid in the borehole may involve drawing off the first fluid and replacing the first fluid with a second fluid having a different electrical conductivity than the first fluid.

Obtaining the first data log may involve obtaining at least a first resistivity log of the borehole and obtaining the second data log may involve obtaining at least a second resistivity log of the borehole, and estimating the mobile water displacement may involve using the first and second resistivity logs to estimate the mobile water displacement from electrical conductivity changes between the first fluid conditions and the second fluid conditions.

Obtaining the first data log may further involve obtaining a data log that facilitates direct determination of the first water volume in the reservoir and obtaining the second data log may further involve obtaining a data log that facilitates direct determination of the second water volume in the reservoir, and may further involve determining whether the first water volume and the second water volume meet a criterion for producing a reliable estimate of the mobile water saturation in the reservoir.

Determining whether the first water saturation and the second water volume meet the criterion may involve determining whether a difference between the first water volume and the second water volume is less then a threshold difference.

Obtaining each of the data logs that facilitate direct determination of the respective first and second water volume in the reservoir includes obtaining at least one of a nuclear magnetic resonance log, an electrical permittivity log, or a gamma spectroscopy log.

Obtaining at least one of the first borehole data log and the second borehole data log may involve obtaining a porosity data log that facilitates determination of a porosity of the reservoir and estimating the mobile water displacement may involve using the porosity data log in estimating the mobile water displacement.

Estimating the mobile water saturation may involve calculating the mobile water saturation in accordance with the relation:

$${Sw}_{mvd} = \frac{{[ \frac{{Sw}_{b}}{{Sw}_{d}} ]}^{n} [ \frac{{R}_{b}}{{R}_{d}} ] - {Sw}_{d}}{\frac{{R}_{b}}{{Rw}_{2}} {φ}^{m} {Sw}_{b}^{n} [ sin ( 45 ° [ \frac{1}{m} + \frac{1}{n} ] ) ] - 1} ;$$

where
Sw_{mvd} is the mobile water saturation;
Sw_{b} is the water saturation in the reservoir under the first fluid conditions;
Sw_{d} is the water saturation in the reservoir under the second fluid conditions;
R_{b} is the formation resistivity under the first fluid conditions;
R_{d} is the formation resistivity under the second fluid conditions;
Rw₂ is the resistivity of a filtrate portion of the second fluid;
φ is the reservoir porosity;
m is the Archie pore tortuosity coefficient; and
n is the Archie saturation tortuosity coefficient.

Changing the fluid conditions may involve changing fluid conditions in the borehole to cause an immiscible displacement of water in the reservoir.

The fluid in the borehole may include a water-based fluid and changing the fluid conditions may involve introducing an oil-based fluid into the borehole to cause the immiscible displacement of mobile water in the reservoir.

The fluid in the borehole may include an oil-based fluid and changing the fluid conditions may involve introducing a water-based fluid into the borehole to cause the immiscible displacement of mobile water in the reservoir.

Estimating the mobile water displacement may involve using the first data log to determine a first water volume in portions of the reservoir in communication with the borehole under the first fluid conditions, and using the second data log to determine a second water volume in portions of the reservoir in communication with the borehole under the second fluid conditions, and using the first and second water volumes to estimate the mobile water displacement.

Using the first and second water volumes to estimate the mobile water displacement may involve determining a difference between the first and second water volumes, using a determined porosity of the reservoir to determine the mobile water saturation of the reservoir based on the difference between the first and second water volumes.

Using the first and second water volumes to estimate the mobile water displacement may involve using a determined porosity of the reservoir to determine first and second water saturations corresponding to the first and second water volumes, and determining a difference between the first and second water saturations, the difference providing the estimate of the mobile water saturation in the reservoir.

The method may involve obtaining a porosity log of the reservoir, the porosity of the reservoir being determined from the porosity log.

Obtaining the first data log may involve obtaining a data log that facilitates direct determination of the first water volume and obtaining the second data log may involve obtaining a data log that facilitates direct determination of the second water volume.

Obtaining the first data log may further involve obtaining a first resistivity data log and obtaining the second data log may further involve obtaining a second resistivity data log and the method may further involve using the first and second resistivity data logs to determine whether the immiscible displacement of water in the reservoir meets a criterion for generating a reliable estimate of the mobile water saturation in the reservoir.

Using the first and second resistivity data logs to determine whether the immiscible displacement of water in the reservoir meets the criterion may involve determining whether resistivity differences provided by the first and second resistivity data logs are consistent with a successful immiscible displacement of water in the reservoir.

Obtaining the first and second borehole data logs may involve using a downhole logging system to generate and record log signals along the borehole.

Generating the estimate of the mobile water saturation may involve post-processing the first and second borehole data logs to generate the estimate of the mobile water saturation.

Obtaining the first and second borehole data logs may involve obtaining the respective data logs at a plurality of borehole locations along the borehole to facilitate a determination of variations in the mobile water saturation in portions of the reservoir disposed in communication with the plurality of borehole locations.

The method may involve using the first and second borehole data logs to facilitate a determination of variations in water salinity in portions of the reservoir disposed in communication with the plurality of borehole locations.

Certain implementations may have one or more of the following advantages. The disclosed embodiments facilitate an in-situ estimation of the mobile water saturation in a reservoir. The fluid change process provides generally similar conditions to conditions that a core sample would be subjected to in a laboratory test conditions, without the need for a core sample. For a steam assisted gravity drainage (SAGD) hydrocarbon recovery operation, the disclosed embodiments may also provide depth variation of mobile water saturation within the reservoir, which facilitates determination of a minimal steam-oil ratio by providing inputs for optimizing well completion strategy.

The estimated mobile water saturation permits an assessment of reservoir dynamics and the potential future productivity of the reservoir. The disclosed fluid circulating process facilitates changing of the fluid conditions in the borehole in such a manner that inhibits undesirable invasion trapping of the reservoir by constituents of the first or second fluids. In some disclosed embodiments, additional data logs may be taken to provide an indication of the reliability of the estimate of mobile water saturation produced.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a cross sectional schematic representation of an exemplary reservoir formation, a borehole through the reservoir, and a logging apparatus for obtaining log data;

FIG. 2 is a flowchart of a process for determining mobile water saturation in accordance with a first embodiment of the invention;

FIG. 3 is a schematic block diagram of a logging unit shown in FIG. 1;

FIG. 4 is a flowchart of a process for implementing a portion of the process shown in FIG. 2; and

FIG. 5 is a flowchart of a process embodiment for estimating mobile water saturation.

### DETAILED DESCRIPTION

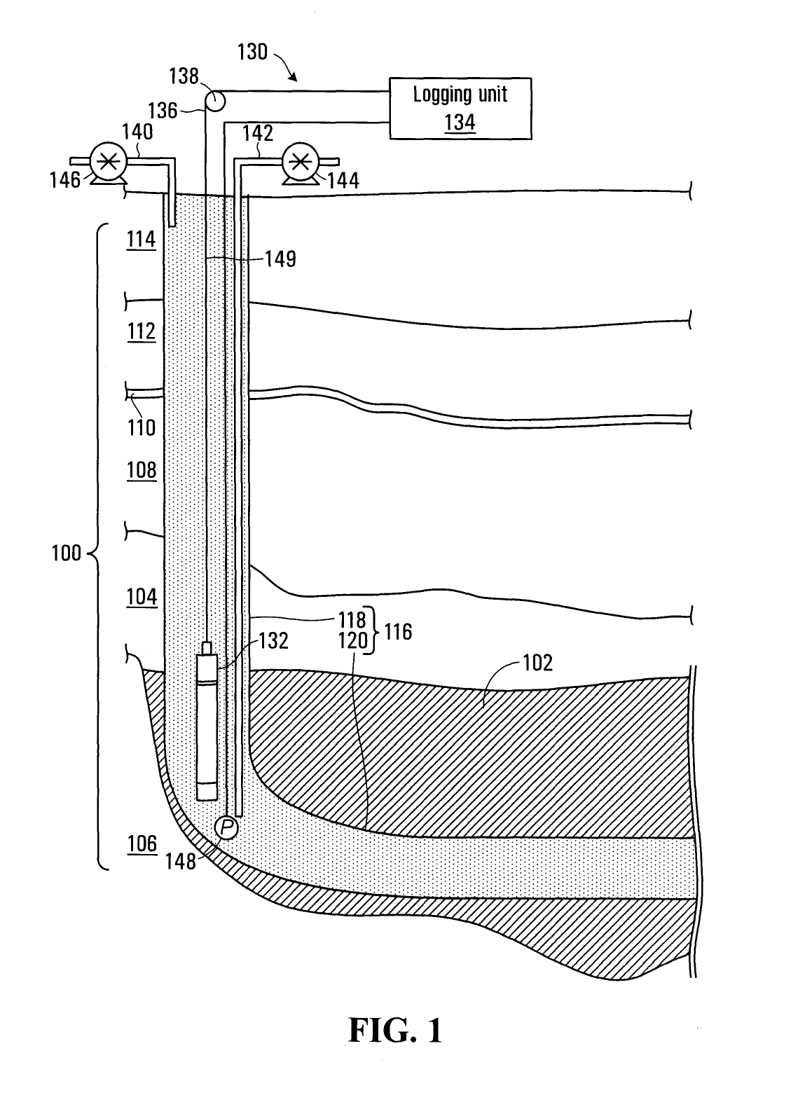

Referring to FIG. 1, an exemplary reservoir formation is shown at 100. In the embodiment shown the formation 100 includes a permeable layer 104, an underlying less permeable or impermeable rock layer 106, and several other rock layers 108-114 overlying the permeable layer 104. The permeable layer 104 includes pores that facilitate accumulation of fluids, which are trapped by the underlying layer 106 to define a reservoir 102 within the permeable layer 104. Fluids trapped in the reservoir 102 may include fluids such as hydrocarbons and water, for example. In the embodiment shown in FIG. 1, the reservoir 102 only occupies a portion of the permeable layer 104, although in other embodiments the reservoir may extend substantially throughout the permeable layer. In one embodiment the permeable layer 104 may comprise a porous rock formation. In other embodiments the permeable layer 104 may comprise sand particles having interstitial spaces in-between particles that act as pores for containing heavy hydrocarbon fluids in the form of bitumen.

In this embodiment a borehole 116 has been drilled through the formation 100. The borehole 116 includes a generally vertical portion 118 extending through rock layers 108-114 into the permeable layer 104, and a generally horizontal portion 120 extending into further portions of the permeable layer 104 that are in communication with the reservoir 102. In other embodiments, the borehole can be differently configured, e.g., substantially vertical without a horizontal portion. The borehole 116 may be drilled using various directional drilling techniques, for example. In one embodiment, the borehole 116 may be one of a pair of boreholes (not shown) for extracting the bitumen using a Steam Assisted Gravity Drainage (SAGD) process. In SAGD recovery operations, steam is injected into one of the boreholes to reduce the viscosity of the heavy hydrocarbons, which then drain to the second borehole and may be produced to the surface. In other embodiments the reservoir may be defined by different rock formations and may contain fluids other than hydrocarbons, such as ground water for example.

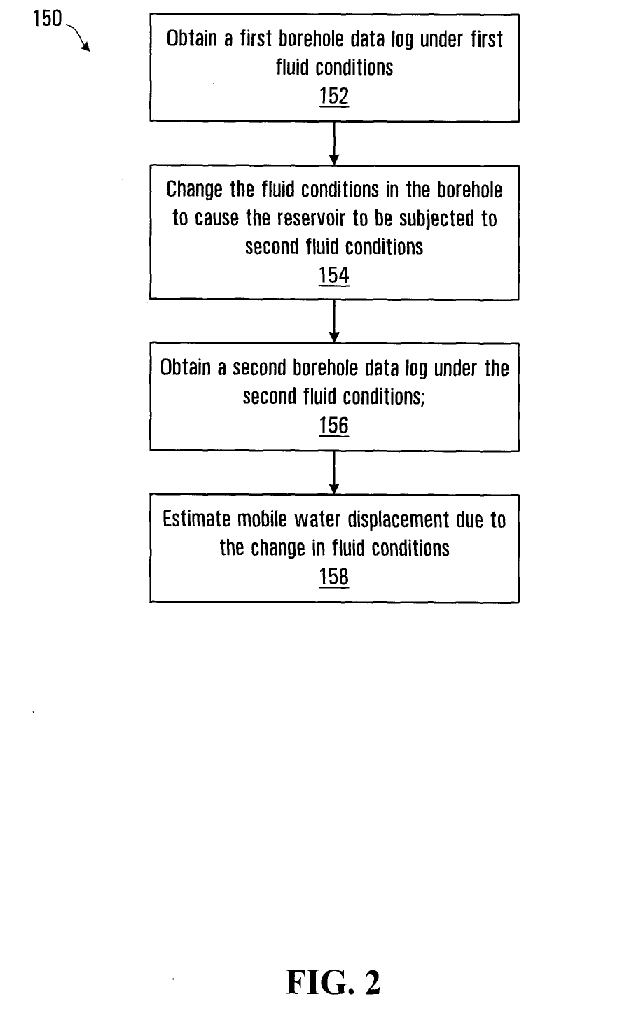

Referring to FIG. 2, a process for determining mobile water saturation in the reservoir 102 according to a first embodiment of the invention is shown in the form of a process flowchart at 150. As shown at 152, the process 150 begins by obtaining a first borehole data log while the reservoir 102 is subjected to first fluid conditions. The first fluid conditions may be provided by a first fluid such as a drilling fluid and the first data log may be a resistivity log or may include a plurality of different data logs. Porosity of the reservoir 102 is used to estimate mobile water saturation. In some implementations, the first borehole data log may include a porosity log that can be used to determine the porosity of the reservoir 102. In some implementations, the first borehole data log includes a log that can be used to determine water volume in the reservoir 102, as is described further below.

As shown at block 154, the process continues with changing of the fluid conditions in the borehole 116 to cause the reservoir 102 to be subjected to second fluid conditions. The change in fluid conditions causes a mobile water displacement in the reservoir, which depending on the nature of the change in fluid conditions may result in invasion of fluid into the reservoir 102 from the borehole 116 or an influx of fluid from the reservoir into the borehole.

The second fluid conditions may be provided by adding fluids to the first fluid or by drawing out the first fluid from the borehole 116 and replacing the first fluid with a second fluid. In general the first and second fluid conditions are selected to cause mobile water displacements in the reservoir 102 that result in detectable differences in some aspect, such as a change in electrical conductivity or a change in water volume within a portion of the reservoir 102 in communication with the borehole 116 as described in greater detail below.

The process then continues at block 156, where a second borehole data log is obtained under the second fluid conditions. The second data log may be a resistivity log or a plurality of different data logs. In general at least one of the second data logs is of the same type as the first data log that was obtained at block 152. For example, where the mobile water displacement causes a conductivity change in the mobile water in the reservoir 102, the first data log may be a resistivity log and the second data logs would also include a resistivity data log.

As shown at block 158, the first and second data logs obtained at block 152 and 156 are then used to estimate the mobile water displacement in the reservoir 102 that occurs due to the change in fluid conditions. In embodiments where the change in fluid conditions causes a conductivity change to a portion of the water volume in the reservoir 102, the mobile water displacement may be estimated from a first resistivity data log taken under the first fluid conditions, a second resistivity data log taken under the second fluid conditions, and from the porosity of the portion of the permeable layer 104 occupied by the reservoir 102.

In other embodiments the change in fluid conditions may involve displacement of mobile water in the reservoir 102 through introduction of an immiscible fluid. In this case a difference between the water saturation under the first fluid conditions (Sw_{b}) and the water saturation under the second fluid conditions (Sw_{d}) may be used to estimate the mobile water displacement. The water saturations Sw_{b} and Sw_{d} may be determined from data logs that provide a direct determination of the water saturations or water volume (which together with the porosity can be used to determine water saturation), such as a Nuclear Magnetic Resonance (NMR) log. The estimated mobile water displacement caused by the change in fluid conditions thus provides an estimate of the mobile water saturation Sw_{mvd} in the reservoir 102.

Various aspects of the process 150 are described in greater detail below.

### First Fluid Conditions

In one embodiment the first fluid conditions may be provided by a first fluid that is used during drilling of the borehole 116. Drilling fluid or drilling mud is commonly used during drilling of boreholes, and is commonly selected based on the type of rock formation and reservoir. Drilling fluids are used for various reasons including stabilization of the rock formation while drilling, cooling of the drill bit, suspension of drill cuttings, and/or removal of drill cuttings from the borehole 116. Drilling fluids may include constituents such as water, oil, polymers, and gas, for example.

In other embodiments, the drilling fluid may be pumped out of the borehole 116 and the first fluid conditions may be provided by a first fluid other than the drilling fluid. Alternatively, the first fluid may be a combination of drilling fluid and other added constituents, such as a polymer, for example.

In general, during drilling and logging operations the composition of the drilling fluid is carefully monitored and thus the properties of the first fluid that provide the first fluid conditions will be continuously measured and/or recorded. For example, properties such as pH, viscosity, resistivity, density and the constituents of the first fluid may be recorded and may be of use in some embodiments for generating the estimate of mobile water saturation described later herein.

The borehole may be conditioned prior to obtaining the first data log to remove deposited mud solids (i.e. filter cake) that could inhibit invasion of the reservoir under either the first or second fluid conditions. Such conditioning may involve scraping of the walls of the borehole to at least partially reverse disturbance of the reservoir formation that occurred during drilling of the borehole 116. For example, scraping would generally remove material from the reservoir face to expose pores of the reservoir that may have become caked with drilling mud. The conditioning may thus improve the reliability of the generated estimate of mobile water saturation by removing impediments to mobile water displacement. A thick filter cake on the walls of the borehole may also provide poor borehole log data results.

### Obtaining the First Data Log

Referring back to FIG. 1, a logging apparatus 130 is disposed to obtain down-hole measurements in the borehole 116. The logging apparatus includes a logging tool 132 and a logging unit 134. A cable 136 extends between the logging tool 132 and the logging unit 134. The cable carries electrical power to the logging tool 132 and also carries various signal lines for communicating measurements and/or instructions between the logging tool and the logging unit 134. In this embodiment the cable 136 is run over a guide pulley 138 and the cable also provides support for raising and lowering the logging tool 132 within the borehole. The logging tool 132 may further include crawlers for negotiating the horizontal portion 120 of the borehole 116. Alternatively, the logging tool 132 may be conveyed on a drill pipe, a semi-rigid coiled tube, by a tractor, or by any other method.

In this embodiment, the logging tool 132 includes a resistivity sensor (not shown) for generating a resistivity log along the borehole. The resistivity log includes at least one measurement of the resistivity of the formation surrounding the logging tool 132, but more generally the log would include a plurality of resistivity values at different depths along the borehole portions 120 and 118 to facilitate determination of variations in the mobile water saturation in the reservoir at various depths.

In general, resistivity logging involves generating a potential difference across a first pair of electrodes to cause a current to flow through a portion of the formation 100. Commonly at least one of the first pair of electrodes is located on the logging tool 132, while the other is located either on the logging tool or elsewhere in the formation 100, for example at the surface. Since most rock formations act essentially as insulators, the established current flow is dependent on the electrical conductivity of the fluid in the borehole 116 and the electrical conductivity of the fluids in the surrounding rock layers. Hydrocarbon fluids generally have high resistivity and the predominant conduction of current would thus occur through saline water deposits contained within the rock formation. The logging tool 132 may further include a second pair of electrodes (also not shown) for measuring a potential difference generated by the current flowing through the surrounding layers. The arrangement and spacing between the first and second pairs of electrodes is selected to provide a desired evaluation volume extending into the layers of the reservoir 102 surrounding the logging tool 132.

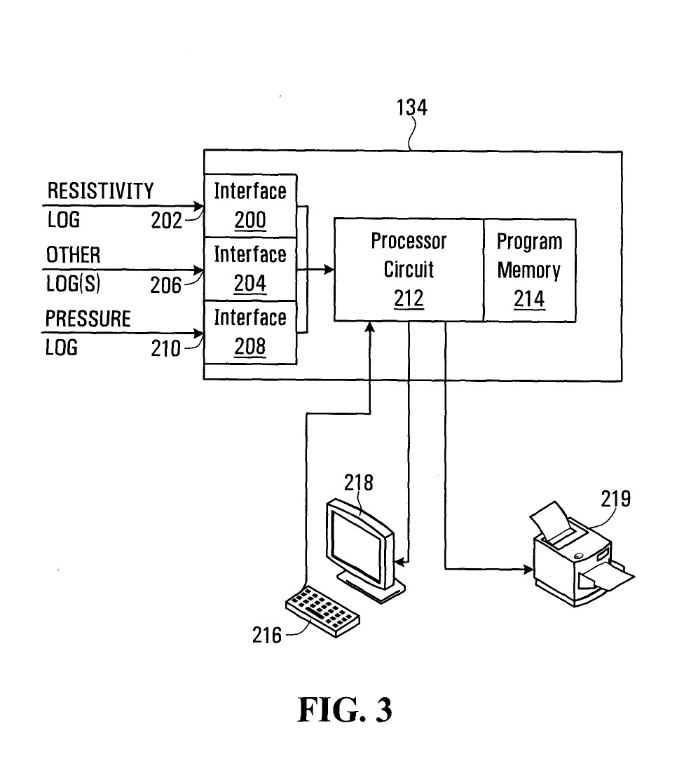

The example logging unit 134 is shown schematically in FIG. 3. Referring to FIG. 3, the logging unit 134 includes an interface 200 having an input 202 for receiving resistivity log data, interface 204 having an input 206 for receiving other log data such as NMR log data, and an interface 208 having an input 210 for receiving pressure data from a downhole pressure transducer 148. Other configurations of logging units may be used and the logging unit 134 shown is but one illustrative example. Referring back to FIG. 1, in the embodiment shown the pressure transducer 148 is disposed in the borehole 116 at about 10 meters above the reservoir bottom, although in other implementations, the pressure transducer 148 can be located at different positions within the borehole. The pressure transducer 148 is carried on a cable 149 that facilitates downhole positioning of the pressure transducer, while also carrying a pressure signal produced by the transducer back to the logging unit 134 to facilitate recording of a pressure log while the process 250 is in progress.

In one embodiment the data received at the inputs 202 and 206 is in the form of an analog signal, and the interfaces 200 and 204 each include digital-to-analog conversion circuitry for converting the analog signals into digital representations of the resistivity log and other log data. In other embodiments, the logging tool 132 generates log data in a digital format transmits a digital signal to the interfaces 200 and 204 over a signal cable or optical fiber. The logging unit 134 further includes a processor circuit 212 in communication with the interfaces 200 and 204 for receiving log data, and interface 208 for receiving downhole pressure data. The processor circuit 212 includes a program memory 214 for storing instructions for execution by the processor circuit 212 for analyzing the log data to produce the log results. The processor circuit 212 is also in communication with a user input device 216 such as a keyboard for receiving user input, and output devices such as a display 218 and a printer 219 for displaying log results or printing a hardcopy record of the log results. In some embodiments the resistivity log data may be recorded onsite at the location of the borehole 116 and may be later analyzed using a processor circuit located at an offsite location.

In general, the log data received at the interface 204 may be selected based on the nature of the change in fluid conditions. For example, if the change in fluid conditions causes an immiscible flood of the reservoir 102, the borehole data logs may include an NMR log data for determining water saturation in the reservoir 102, as described above. Other examples of such logs may include, but are not limited to a carbon/oxygen ratio log, a dielectric permittivity log, an excessive carbon yield log, or any other fluid volume log. The aforementioned logs each facilitate determination of the water saturation in the reservoir 102. For example, carbon and oxygen yields are obtained from gamma ray spectral measurements and the carbon and oxygen yields may be used in estimating weight percentages of fluid and minerals. A ratio between carbon and oxygen is used to estimate water mass and hence water saturation Sw_{b} from an assumed water density. Excessive carbon yield is another gamma ray spectral measurement, where the carbon yield is used in combination with other logs to estimate rock carbonate mineral concentrations. An excessive carbon yield is then estimated, which provides an oil mass estimation. Dielectric multi-frequency permittivity may also be used to evaluate water permittivity in a formation, which may in turn be used to evaluate water saturation in the formation. Permittivity is independent of water salinity at high frequencies.

The logs can be processed using available log analysis software tools to remove the effect of the borehole fluid on the measurements to produce log data that represents the water saturation in the formation. Such processing can be done on or off site once the data logs have been recorded at the borehole 116.

Oilfield services companies such as such as Schlumberger and Halliburton provide access to logging units for performing logging of formations and analysis software for analyzing the log data to provide estimates of formation resistivity, water saturations, porosity, and other formation characteristics. Resistivity and other logs are generally provided in the form of a graph or table of values at a plurality of depths down or along the borehole and such logs may be used to determine depth variations in various reservoir characteristics, such as salinity, for example.

### Changing of Fluid Conditions

As noted above, the first and second fluid conditions are selected to cause a mobile water displacement in the reservoir 102 that provide a difference or contrast that is detectable in the obtained data logs.

In one embodiment, the second fluid conditions may be provided by a second fluid that causes a miscible invasion of the reservoir 102. The second fluid may have higher salinity than the first fluid which would reduce the resistivity (i.e. increase the conduction of current through the second fluid into the reservoir layers surrounding the logging tool). Alternatively, the second fluid may have negligible or low salinity relative to the first fluid. For first and second water-based fluids, the resulting change in fluid salinity conditions cause a change in conductivity with respect to the existing water in the reservoir by introducing different water into the reservoir through miscible displacement. This results in a difference in resistivity measured by resistivity logs under the changed fluid conditions.

In other embodiments, the second fluid may include constituents that are substantially insoluble in water causing an immiscible invasion of the reservoir that reduces the existing water volume in the reservoir 102 through water insoluble fluid immiscible displacement. Immiscible displacement of water in the reservoir 102 by insoluble hydrocarbon fluids, which generally are non-conducting, has the effect or reducing the overall measured resistivity through the reservoir 102. Examples of constituents of insoluble second fluids may include hydrocarbons, polymers, or drilling mud. Such hydrocarbon based fluids may further include a hydrocarbon insoluble mud or an oil-based inverted mud. In one embodiment the first fluid may comprise a water based drilling fluid and the second fluid can be an oil-based mud having a viscosity of 12 cp, a density of 1050 kg/m³ and a Nuclear Magnetic Resonance (NMR) transverse relaxation time (T2) of about 100 milliseconds. Such a second fluid would result in an immiscible displacement of mobile water in the reservoir 102 and would also facilitate use of NMR logging to determine the remaining water saturation Sw_{d} under the second fluid conditions.

In other embodiments, the second fluid may comprise a volume of gas such as carbon dioxide, natural gas, or steam, which may be injected under pressure into the borehole 116. In another embodiment the second fluid may be introduced into the borehole 116 at a positive pressure in an attempt to reduce possible damage around the borehole 116 and to allow only miscible invasion of the fluid. This embodiment may be helpful in establishing the possibility of a miscible flood and a change in conductivity of the water volume in the rock formation.

Drilling fluids are usually introduced into the borehole during drilling through a conduit extending through the drill string. However, the drill string would generally be removed to permit data logging. Referring back to FIG. 1, in the embodiment shown the borehole 116 further includes an inlet 140 for introducing fluid into the borehole and an outlet 142 for drawing off fluid from the borehole. The outlet 142 is in communication with a downhole location in the borehole 116 and is coupled to a pump 144 that is operable to draw fluid out of the borehole from the downhole location and deposit the fluid in a mud pit or other container (not shown). The inlet 140 is in communication with a portion of the borehole proximate the surface and is coupled to pump 146 for receiving fluid that is either circulated back from the mud pit, or provided from an alternative fluid supply.

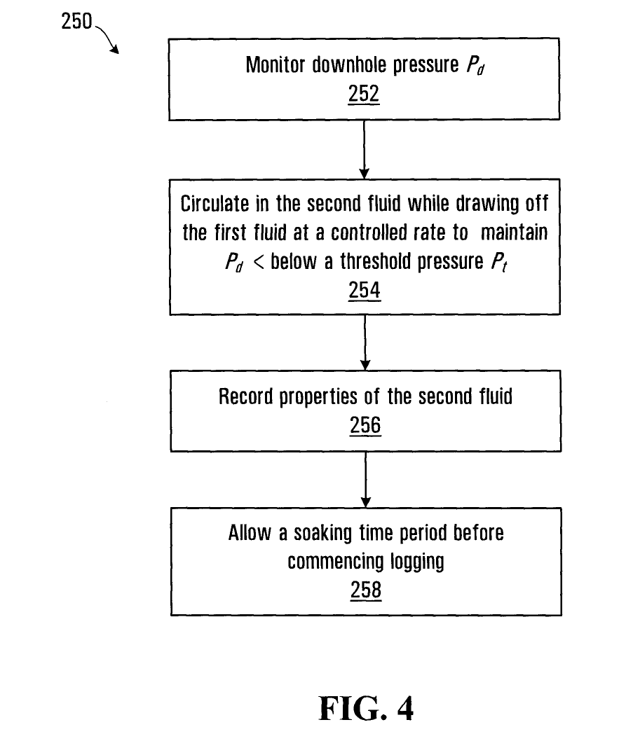

An embodiment of a process flowchart for changing of fluid conditions in the borehole (as shown at block 154 in FIG. 2) is shown as a process flowchart in FIG. 4. Referring to FIG. 4, the process 250 begins at block 252 by commencing monitoring the borehole hydrostatic pressure (P_{d}) at the face of the reservoir 102 using signals provided by the pressure transducer 148 (shown in FIG. 1).

As shown at block 254 of FIG. 4, the second fluid is then circulated into the borehole 116 by operating the pump 146 to pump the second fluid through the inlet 140. At the same time, the pump 144 is operated to draw the first fluid from the borehole 116 through the outlet 142, and the pumping rates of the pumps 144 and 146 can be controlled to provide a slow steady change to the fluid conditions and to prevent significant downhole pressure increases as monitored by the pressure transducer 148. In one embodiment, circulation process is controlled to maintain a downhole pressure P_{d} that is below a threshold pressure Pₜ. The threshold pressure Pₜ may correspond to a fracture pressure associated with the reservoir 102.

In one embodiment the circulating at block 254 is performed over a circulating time period having a duration of about 30 minutes, and may also involve monitoring of the respective flow volumes through the pumps 144 and 146 to detect any possible loss of fluid. A loss of fluid that cannot be attributed to the circulating process may be due to an undesirable reservoir invasion, such as a fracture of a portion of the reservoir that may cause misrepresentation of the estimated mobile water saturation. In general, the circulating should be performed to avoid capillary trapping, a condition in which the fluid in the borehole invades the reservoir 102, and once present, is held in place by capillary forces within the reservoir pores. Such trapping may cause a misrepresentation of the actual mobile water saturation in the reservoir 102.

At block 256, properties of the fluid such as pH, viscosity, resistivity, density and the constituents of the second fluid may be recorded for use in the estimation of mobile water displacement as described in more detail below.

As noted above, the downhole pressure produced by the pressure transducer 148 is monitored during circulating and used to control the circulating process, but also forms a useful record for later analysis in evaluating whether the mobile water saturation estimates produced in accordance with the process 150 in FIG. 2 correctly represent the actual condition of the reservoir 102. Any significant downhole pressure deviations that occur may be an indication of undesirable reservoir invasion by fluids or solids in the borehole, which may impact the mobile water displacement under the changed fluid conditions. For example, a spike in pressure may exceed the threshold pressure Pₜ, resulting in fracturing of the reservoir, following which the pressure would suddenly drop.

Generally the borehole would be enclosed by a well-head proximate the surface, and during circulating at block 254 pressure buildup due release of gaseous products from the first or second fluids may cause a pressure build-up at the surface. An increase in pressure in the borehole that occurs during the changing of the fluid conditions may be bled off or otherwise relieved prior to logging, since logging may be dangerous under high pressure conditions, unless special precautions are taken.

As shown at block 258, in this embodiment the process 250 further includes a soaking time period, during which the second fluid conditions are allowed to reach a state of equilibrium. In one embodiment the soaking time period may be about 30 minutes, which should be sufficient to reach equilibrium without incurring a significant delay in completion of the process 150 shown in FIG. 2. On expiry of the soaking time period, the fluid change process 250 is completed and the second borehole data log may proceed as shown at block 156 of the process 150 in FIG. 2.

A further optional verification of the integrity of the borehole after changing the fluid conditions at block 254 may be performed subsequent to, or during the soaking time period. For example, verifying the integrity of the borehole may involve obtaining a caliper log of a diameter of the borehole through the reservoir. Any detected discontinuities in borehole diameter may be an indication of damage to the wellbore due to a cave in, for example. Such borehole integrity problems may have an impact on the reliability of the generated estimates of mobile water saturation.

Advantageously, the circulating process 250 shown in FIG. 4 facilitates changing of the fluid conditions in the borehole 116 in such a manner that inhibits undesirable invasion trapping of the reservoir 102 by constituents of the first or second fluids. In general, the first and second fluids may include combinations of liquids such as water and hydrocarbon (i.e. a filtrate portion) and suspended solids, such as clay. It is desirable that a filtrate portion of the fluids be able to invade the reservoir 102 to displace in-situ mobile water. However, it is not desirable to cause suspended solids present in the first and second fluids (such as clay, for example) to enter the reservoir pores.

Other drilling mud handling procedures may be used or adapted to implement process block 154 of FIG. 2 for changing the fluid conditions. For some stable formations the first mud may be pumped out before the second fluid is pumped in. However for many formations stability issues in the reservoir and/or borehole may prohibit a simple changing of the fluid and the process shown in FIG. 4 and in such cases other suitable processes may be implemented.

In general it is desirable that there be a resistivity contrast between the first and second fluid conditions and thus if the first fluid were to be highly saline, a low saline second fluid may provide good contrast. Similarly, if the second fluid were to be of low salinity, a more saline second fluid could be used to enhance the resistivity contrast. In some embodiments, stability issues in the reservoir and/or borehole may prohibit pumping out the first fluid, in which case polymers and/or other non-conductive chemicals may be used to maintain stability of the borehole and reservoir while providing the required contrast between the first and second fluids. For example, the first fluid may be selected to be an oil based mud or less saline mud and the second fluid may be selected to be a fluid of high electrical conductivity contrast that is also likely to reduce potential stability issues.

### Obtaining Second Data Log

In general, the second data log under second fluid conditions obtained at block 156 would include the corresponding data logs to those obtained under the first fluid conditions. However, in embodiments where a reservoir porosity log is obtained to determine porosity of the reservoir 102, the reservoir porosity may be assumed to be the same under the first and second fluid conditions. Accordingly a porosity log would not need to be repeated under both the first and second fluid conditions but may only be obtained under either the first or second fluid conditions. The second data log may include a resistivity log and may further include an additional log for direct determination of the second water volume, which can be used together with the porosity to determine the second water saturation Sw_{d} under the second fluid conditions. The configuration of the logging tool 132 for obtaining the second data log would also generally correspond to the configuration for obtaining the first data log at block 154 of the process 150, although there may be so changes to logging parameters associated with obtaining reliable log data under the second fluid conditions.

### Processing Data Logs

Processing of the first and second data logs using available log analysis software will provide values for the water saturations Sw_{b} and Sw_{d} in the reservoir 102 under the respective first and second fluid conditions. The data logs obtained at blocks 152 and 156 will generally provide values over a range of depths along the borehole 116 and the processing would provide a corresponding depth variation of the first and second water saturations through the reservoir.

### Estimating Mobile Water Displacement

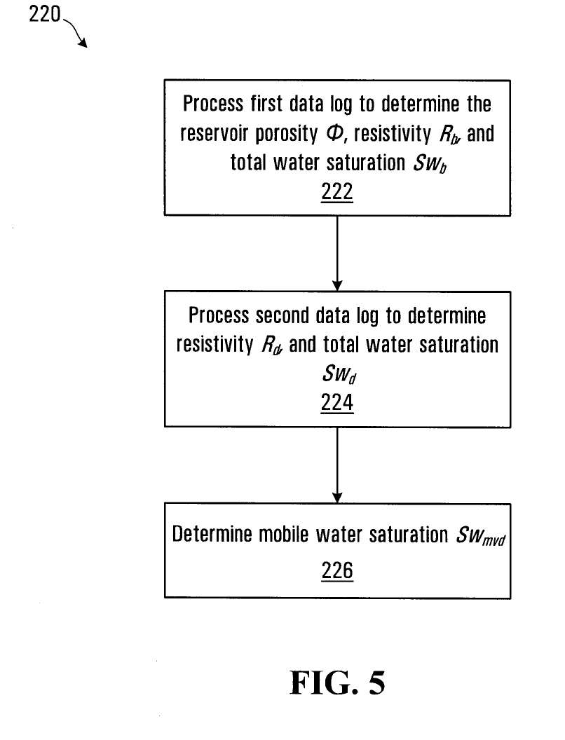

As described above, in one embodiment the first and second fluid conditions are selected to cause miscible displacement of mobile water in the reservoir 102. Such conditions may be provided by a second fluid that has a high resistivity contrast with respect to the first fluid. A process for estimating mobile water saturation in accordance with this embodiment is shown in FIG. 5 at 220. As shown at block 222, the process commences with the processing of the first data log obtained at block 152 of the process 150 shown in FIG. 2. In this embodiment the first data log includes a resistivity log and a porosity log that facilitates determination of the porosity of the reservoir. Data from the resistivity log can be used together with the porosity of the reservoir, resistivity of the first fluid and the Archie pore tortuosity exponent (m) and the Archie saturation tortuosity exponent (n) to estimate the water saturation of the reservoir under the first fluid conditions.

In some implementations, an additional data log (e.g., an NMR data log) may also be obtained and processed at block 222 to provide the water volume under the first fluid conditions, from which the water saturation Sw_{b} under the first fluid conditions also can be determined, using the porosity. The estimated value of the water saturation determined as described above using the resistivity log can be compared to the water saturation determined from the additional data log. The two values should be substantially the same. If the two values are not substantially the same, this may be an indicator that the determined mobile water saturation of the reservoir using the process described will not be reliable. It may be that the m and/or n values used in estimating the water saturation from the resistivity log data were not correctly selected, and adjusting the values in accordance with the resistivity profile may result in the two values of estimated water saturation corresponding, i.e., falling within a predetermined threshold range of each other.

As shown at block 224, the process continues with the processing of the second data logs obtained at block 156 of the process 150. In general, the second data logs may include logs that correspond to the data logs obtained under the first fluid conditions, except that as noted above, the porosity log may be omitted. Accordingly, the resistivity log obtained under the under the second fluid conditions is processed to provide the resistivity R_{b}, and an additional log (e.g. an NMR log) can be obtained and processed to provide a second estimate of the second water saturation Sw_{d} (based on the porosity of the reservoir).

At block 226, the values of R_{b}, Rₐ, φ, Sw_{b}, and Sw_{d} are then used to estimate the mobile water saturation Sw_{mvd}. In one embodiment the mobile water saturation may be determined in accordance with the following relation:

$${Sw}_{mvd} = \frac{{[ \frac{{Sw}_{b}}{{Sw}_{d}} ]}^{n} [ \frac{{R}_{b}}{{R}_{d}} ] - {Sw}_{d}}{\frac{{R}_{b}}{{Rw}_{2}} {φ}^{m} {Sw}_{b}^{n} [ sin ( 45 ° [ \frac{1}{m} + \frac{1}{n} ] ) ] - 1} ; \qquad Equation 1$$

where:
Sw_{mvd} is the mobile water saturation;
Sw_{b} is the water saturation in the reservoir under the first fluid conditions;
Sw_{d} is the water saturation in the reservoir under the second fluid conditions;
R_{b} is the formation resistivity under the first fluid conditions;
R_{d} is the formation resistivity under the second fluid conditions;
Rw₂ is the resistivity of a filtrate portion of the second fluid;
φ is the reservoir porosity;
m is the Archie pore tortuosity exponent; and
n is the Archie saturation tortuosity exponent.

The Archie pore tortuosity or cementation exponent (m) and saturation tortuosity exponent (n) may be obtained from external sources, such as core analysis. Alternatively, an assumed value for m of 2.0 and an assumed value for n of 2.0 may be used for most sandstone and carbonate reservoirs. In some implementations, the resistivity log from the first borehole data logs can be used to select appropriate values of m and n.

Under fluid conditions that cause miscible displacement of mobile water in the reservoir 102, it is expected that the water saturation in the reservoir 102 would not change significantly and thus Sw_{b} and Sw_{d} should be substantially similar under the respective first and second fluid conditions. Advantageously, any significant differences between the water saturations Sw_{b} and Sw_{d} would be indicative that the fluid change may not produce a reliable estimate of the mobile water saturation in the reservoir. Accordingly, the difference between the water saturations Sw_{b} and Sw_{d} provide a criterion for determining whether a particular implementation of the process 220 would produce a reliable estimate of the mobile water saturation in the reservoir. In one embodiment a threshold difference may be established for a particular reservoir 102 and the estimate of mobile water saturation may be considered to be reliable as long as the difference between Sw_{b} and Sw_{d} remains less than the threshold difference.

Equation 1 above represents one possible method for calculating mobile water saturation under miscible displacement conditions and other methods may equally well be applied.

In another embodiment the first and second fluid conditions may be selected to cause an immiscible displacement of mobile water in the reservoir 102. As noted above, such conditions may be provided by an oil-based second fluid that displaces mobile water in the reservoir 102. In one specific embodiment, data logs may be obtained to provide a first water volume in the reservoir under the first fluid conditions and a second water volume in the reservoir under second fluid conditions. First and second water saturations Sw_{b} and Sw_{d} may be determined from the first and second water volumes using the reservoir porosity, which may be determined from a porosity log or another method such as a core analysis, for example. The Sw_{b} and Sw_{d} values may be used to generate the mobile water saturation estimate in accordance with the following relation:

Sw_{mvd}=Sw_{b}−Sw_{d}. Equation 2

The water saturation values Sw_{b} and Sw_{d} may be obtained from a log such as an NMR log that provides a direct indication of water volume, which can be used with the determined porosity of the reservoir to estimate the water saturation values.

In another implementation, the mobile water displacement may be determined as a water volume by determining a difference between the first water volume and the second water volume, and the water volume difference may be used with the determined porosity of the reservoir to estimate the water saturation values.

While Equation 2 above does not involve resistivity, resistivity logs may also be obtained under the first and second fluid conditions and processed to provide respective resistivity values R_{b} and Rₐ. The values of R_{b} and Rₐ, while not required for calculation of Sw_{mvd} in the Equation 2 embodiment above, may provide a useful confirmation of a successful invasion of the reservoir 102 by the immiscible second fluid. As an example, hydrocarbons generally have a low electrical conductivity, and a second hydrocarbon based fluid would thus generally have low conductivity. Should conditions in the borehole 116 prevent fluid invasion of the reservoir 102, the resistivity values R_{b} and Rₐ provided by the respective first and second logs for such a hydrocarbon based fluid invasion would not differ significantly, providing an indication that application of Equation 2 above may not provide a reliable estimate of the mobile water saturation in the reservoir. Accordingly, a comparison of the resistivity values R_{b} and Rₐ provides a useful criterion for determining whether an estimate of the mobile water saturation in a reservoir can be relied on.

While specific embodiments of the invention have been described and illustrated, such embodiments should be considered illustrative of the invention only and not as limiting the invention as construed in accordance with the accompanying claims.

What is claimed is:

1. A method for determining mobile water saturation in a reservoir having a borehole extending through the reservoir, the method comprising:
obtaining first borehole data logs while the reservoir is subjected to first fluid conditions, the first borehole data logs including:
a first resistivity data log; and
at least one data log that facilitates direct determination of a first water volume in the reservoir;
causing a mobile water displacement in the reservoir by changing the fluid conditions in the borehole to cause the reservoir to be subjected to second fluid conditions, the second fluid conditions differing from the first fluid conditions;
obtaining second borehole data logs under the second fluid conditions, the second borehole data logs including:
a second resistivity data log; and
at least one data log that facilitates direct determination of a second water volume in the reservoir;
estimating the mobile water displacement using the first and second data logs; and
based on the estimated mobile water displacement and a determined porosity of the reservoir, determining the mobile water saturation of the reservoir.

2. The method of claim 1, further comprising:
obtaining a porosity log of the reservoir, wherein the porosity of the reservoir is determined from the porosity log.

3. The method of claim 1 wherein:
changing the fluid conditions in the borehole comprises changing electrical conductivity properties of the fluid in the borehole; and
estimating the mobile water displacement comprises using the first and second resistivity logs to estimate the mobile water displacement from electrical conductivity changes between the first fluid conditions and the second fluid conditions.

4. The method of claim 3 wherein obtaining at least one of the first borehole data logs and the second borehole data logs comprises obtaining a porosity data log that facilitates determination of a porosity of the reservoir and wherein estimating the mobile water displacement comprises using the porosity data log in estimating the mobile water displacement.

5. The method of claim 3 further comprising comparing the first water saturation and the second water saturation and based on the comparison determining whether a criterion is satisfied for generating a reliable estimate of the mobile water saturation in the reservoir based on the first and second borehole data logs.

6. The method of claim 5 wherein determining whether the criterion is satisfied comprises determining whether a difference between the first water saturation and the second water saturation is less then a threshold difference.

7. The method of claim 1 wherein obtaining each of the data logs that facilitate direct determination of the respective first and second water volumes in the reservoir comprises obtaining at least one of:
a nuclear magnetic resonance log;
an electrical permittivity log; or
a gamma spectroscopy log.

8. The method of claim 1 wherein changing the fluid conditions comprises changing fluid conditions of the fluid in the borehole to cause an immiscible displacement of water in the reservoir and wherein estimating the mobile water displacement comprises determining a difference between the first and second water saturations.

9. The method of claim 8 further comprising using a comparison of the first and second resistivity data logs to determine whether the immiscible displacement of water in the reservoir meets a criterion for generating a reliable estimate of the mobile water saturation in the reservoir.

10. The method of claim 9 wherein using a comparison of the first and second resistivity data logs to determine whether the immiscible displacement of water in the reservoir meets the criterion comprises determining whether resistivity differences between the first and second resistivity data logs are consistent with a successful immiscible displacement of water in the reservoir.

11. A method for determining mobile water saturation in a reservoir having a borehole extending through the reservoir, the method comprising:
obtaining a first borehole data log while the reservoir is subjected to first fluid conditions;
causing a mobile water displacement in the reservoir by changing the fluid conditions in the borehole to cause the reservoir to be subjected to second fluid conditions, the second fluid conditions differing from the first fluid conditions;
obtaining a second borehole data log under the second fluid conditions; and
estimating the mobile water displacement using the first and second data logs, the estimated mobile water displacement providing an estimate of the mobile water saturation in the reservoir.

12. The method of claim 1 wherein changing the fluid conditions in the borehole comprises introducing into the borehole, at least one of:
water;
a hydrocarbon fluid;
a polymer fluid;
a drilling fluid;
an oil-based inverted drilling fluid;
steam; or
an inert gas.

13. The method of claim 11 wherein the first fluid conditions are provided by a first fluid in the borehole and wherein changing the fluid conditions in the borehole comprises circulating the first fluid out of the borehole over a circulating time period, the circulating comprising:
drawing the first fluid from the borehole; and
while drawing the first fluid from the borehole, introducing a second fluid into the borehole, the second fluid providing the second fluid conditions.

14. The method of claim 13 further comprising:
monitoring a downhole pressure proximate a portion of the borehole in communication with the reservoir during the circulating; and
controlling the circulating to maintain the downhole pressure below a threshold pressure.

15. The method of claim 14 wherein the threshold pressure corresponds to a fracture pressure associated with the reservoir.

16. The method of claim 14 further comprising performing a verification of the estimate of the mobile water saturation by determining whether the monitored pressure during the circulating meets a criterion for generating a reliable estimate of the mobile water saturation in the reservoir.

17. The method of claim 16 wherein determining whether the monitored pressure meets the criterion comprises determining whether the monitored downhole pressure remains below a pressure threshold associated with capillary trapping of fluid in pores of the reservoir during the circulating.

18. The method of claim 13 wherein the circulating time period has a duration of at least about 30 minutes.

19. The method of claim 18 further comprising allowing a soaking time period having a duration of about 30 minutes between completion of the circulating and obtaining the second borehole data log.

20. The method of claim 13 wherein the first fluid comprises a drilling fluid for facilitating drilling of the borehole through the reservoir.

21. The method of claim 11 further comprising determining properties of the fluid in the borehole under the first fluid conditions and determining properties of the fluid in the borehole under the second fluid conditions.

22. The method of claim 21 wherein determining the properties of the fluid in the borehole comprises determining at least one of:
a pH of the first fluid;
a viscosity of the first fluid;
a resistivity of the first fluid;
a density of the first fluid; or
a composition of the first fluid.

23. The method of claim 11 wherein the borehole is enclosed by a well-head proximate the surface and further comprising relieving an increase in pressure in the borehole proximate the surface that occurs during the changing of the fluid conditions.

24. The method of claim 11 further comprising conditioning the borehole prior to obtaining the first data log.

25. The method of claim 24 wherein conditioning the borehole comprises scraping the borehole before obtaining the first data log.

26. The method of claim 11 further comprising verifying the integrity of the borehole after changing the fluid conditions.

27. The method of claim 26 wherein verifying the integrity of the borehole comprises obtaining a caliper log of a diameter of the borehole through the reservoir.

28. The method of claim 11 wherein changing the fluid conditions in the borehole comprises changing electrical conductivity properties of the fluid in the borehole.

29. The method of claim 28 wherein the fluid in the borehole comprises a first fluid and wherein changing the electrical conductivity properties of the fluid in the borehole comprises drawing off the first fluid and replacing the first fluid with a second fluid having a different electrical conductivity than the first fluid.

30. The method of claim 28 wherein obtaining the first data log comprises obtaining at least a first resistivity log of the borehole and wherein obtaining the second data log comprises obtaining at least a second resistivity log of the borehole, and wherein estimating the mobile water displacement comprises using the first and second resistivity logs to estimate the mobile water displacement from electrical conductivity changes between the first fluid conditions and the second fluid conditions.

31. The method of claim 30 wherein obtaining the first data log further comprises obtaining a data log that facilitates direct determination of a first water volume in the reservoir and wherein obtaining the second data log further comprises obtaining a data log that facilitates direct determination of a second water volume in the reservoir, and further comprising determining whether the first water volume and the second water volume meet a criterion for producing a reliable estimate of the mobile water saturation in the reservoir.

32. The method of claim 31 wherein determining whether the first water volume and the second water volume meet the criterion comprises determining whether a difference between the first water volume and the second water volume is less then a threshold difference.

33. The method of claim 31 wherein obtaining each of the data logs that facilitate direct determination of the respective first and second water volumes in the reservoir includes obtaining at least one of:
a nuclear magnetic resonance log;
an electrical permittivity log; or
a gamma spectroscopy log.

34. The method of claim 28 wherein obtaining at least one of the first borehole data log and the second borehole data log comprises obtaining a porosity data log that facilitates determination of a porosity of the reservoir and wherein estimating the mobile water displacement comprises using the porosity data log in estimating the mobile water displacement.

35. The method of claim 28 wherein estimating the mobile water saturation comprises calculating the mobile water saturation in accordance with the relation:
$${Sw}_{mvd} = \frac{{[ \frac{{Sw}_{b}}{{Sw}_{d}} ]}^{n} [ \frac{{R}_{b}}{{R}_{d}} ] - {Sw}_{d}}{\frac{{R}_{b}}{{Rw}_{2}} {φ}^{m} {Sw}_{b}^{n} [ sin ( 45 ° [ \frac{1}{m} + \frac{1}{n} ] ) ] - 1} ;$$
where
Sw_{mvd} is the mobile water saturation;
Sw_{b} is the water saturation in the reservoir under the first fluid conditions;
Sw_{d} is the water saturation in the reservoir under the second fluid conditions;
R_{b} is the formation resistivity under the first fluid conditions;
R_{d} is the formation resistivity under the second fluid conditions;
Rw₂ is the resistivity of a filtrate portion of the second fluid;
φ is the reservoir porosity;
m is the Archie pore tortuosity coefficient; and
n is the Archie saturation tortuosity coefficient.

36. The method of claim 11 wherein changing the fluid conditions comprises changing fluid conditions in the borehole to cause an immiscible displacement of water in the reservoir.

37. The method of claim 36 wherein the fluid in the borehole comprises a water-based fluid and wherein changing the fluid conditions comprises introducing an oil-based fluid into the borehole to cause the immiscible displacement of mobile water in the reservoir.

38. The method of claim 36 wherein the fluid in the borehole comprises an oil-based fluid and wherein changing the fluid conditions comprises introducing a water-based fluid into the borehole to cause the immiscible displacement of mobile water in the reservoir.

39. The method of claim 36 wherein estimating the mobile water displacement comprises:
using the first data log to determine a first water volume in portions of the reservoir in communication with the borehole under the first fluid conditions;
using the second data log to determine a second water volume in portions of the reservoir in communication with the borehole under the second fluid conditions; and
using the first and second water volumes to estimate the mobile water displacement.

40. The method of claim 39 wherein using the first and second water volumes to estimate the mobile water displacement comprises:
determining a difference between the first and second water volumes; and
using a determined porosity of the reservoir to determine the mobile water saturation of the reservoir based on the difference between the first and second water volumes.

41. The method of claim 40, further comprising:
obtaining a porosity log of the reservoir, wherein the porosity of the reservoir is determined from the porosity log.

42. The method of claim 39 wherein using the first and second water volumes to estimate the mobile water displacement comprises:
using a determined porosity of the reservoir to determine first and second water saturations corresponding to the first and second water volumes; and
determining a difference between the first and second water saturations, the difference providing the estimate of the mobile water saturation in the reservoir.

43. The method of claim 42, further comprising:
obtaining a porosity log of the reservoir, wherein the porosity of the reservoir is determined from the porosity log.

44. The method of claim 39 wherein obtaining the first data log comprises obtaining a data log that facilitates direct determination of the first water volume and wherein obtaining the second data log comprises obtaining a data log that facilitates direct determination of the second water volume.

45. The method of claim 44 wherein obtaining the first data log further comprises obtaining a first resistivity data log and wherein obtaining the second data log further comprises obtaining a second resistivity data log and further comprising using the first and second resistivity data logs to determine whether the immiscible displacement of water in the reservoir meets a criterion for generating a reliable estimate of the mobile water saturation in the reservoir.

46. The method of claim 45 wherein using the first and second resistivity data logs to determine whether the immiscible displacement of water in the reservoir meets the criterion comprises determining whether resistivity differences provided by the first and second resistivity data logs are consistent with a successful immiscible displacement of water in the reservoir.

47. The method of claim 11 wherein obtaining the first and second borehole data logs comprises using a downhole logging system to generate and record log signals along the borehole.

48. The method of claim 11 wherein generating the estimate of the mobile water saturation comprises post-processing the first and second borehole data logs to generate the estimate of the mobile water saturation.

49. The method of claim 11 wherein obtaining the first and second borehole data logs comprises obtaining the respective data logs at a plurality of borehole locations along the borehole to facilitate a determination of variations in the mobile water saturation in portions of the reservoir disposed in communication with the plurality of borehole locations.

50. The method of claim 11 further comprising using the first and second borehole data logs to facilitate a determination of variations in water salinity in portions of the reservoir disposed in communication with the plurality of borehole locations.
